(19) United States
(12) Patent Application Publication
(10) Pub. No.: US 2019/0124194 A1
(43) Pub. Date: Apr. 25, 2019

(54) NEAR-FIELD COMMUNICATION INITIATED BLUETOOTH PAIRING BETWEEN MOBILE DEVICE AND GAS DETECTOR

(71) Applicant: Honeywell International Inc., Morris Plains, NJ (US)

(72) Inventor: Scott Stolte, Millbrae, CA (US)

(21) Appl. No.: 15/790,698

(22) Filed: Oct. 23, 2017

(51) Int. Cl. H04M 1/725; G08B 21/14; H04W 12/06

(52) U.S. Cl. CPC H04M 1/7253; H04W 12/06; G08B 21/14; H04M 1/72572

(57) ABSTRACT

Embodiments relate generally to systems and methods for establishing a wireless connection between a gas detector and a mobile device. A method may comprise monitoring, by one of the gas detector and/or mobile device, for a peer device within a first communication range, wherein the peer device comprises the second of the gas detector and/or mobile device; detecting, by one of the gas detector and/or mobile device, a peer device within the first communication range; establishing a first wireless connection with the detected peer device; sending, by the gas detector to the mobile device, connection data for a second wireless connection, wherein the connection data comprises an identifier and a secure PIN; receiving, by the mobile device, the connection data; selecting, by the mobile device, the gas detector using the identifier; and establishing the second wireless connection with the gas detector using the secure PIN.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Gas detectors often may be carried by workers and/or located throughout a work place and may detect gases in the environment. Gas detectors may be configured to alert a user and/or supervisor when a harmful gas or level of gas is detected. Gas detectors may also be configured to communicate sensed information to a monitoring station.

### SUMMARY

In an embodiment, a method for establishing a wireless connection between a gas detector and a mobile device may comprise monitoring, by one of the gas detector and/or mobile device, for a peer device within a first communication range, wherein the peer device comprises the second of the gas detector and/or mobile device; detecting, by one of the gas detector and/or mobile device, a peer device within the first communication range; establishing a first wireless connection with the detected peer device; sending, by the gas detector to the mobile device, connection data for a second wireless connection, wherein the connection data comprises an identifier and a secure PIN; receiving, by the mobile device, the connection data; selecting, by the mobile device, the gas detector using the identifier; and establishing the second wireless connection with the gas detector using the secure PIN.

In an embodiment, a communication system may comprise a gas detector configured to detect one or more hazardous gasses, comprising a memory, a processor, a first communication module, and a second communication module; and a mobile device comprising a memory, a processor, a first communication module, and a second communication module, and configured to detect that the gas detector is within a first communication range of the first communication module of the mobile device; establish a first wireless connection, via the first communication module, with the detected gas detector; receive connection data for a second wireless connection, wherein the connection data comprises an identifier and a secure PIN; select the gas detector using the identifier; and establish the second wireless connection with the gas detector using the secure PIN.

In an embodiment, a method for establishing a Bluetooth connection between a gas detector and a mobile device, wherein the gas detector is configured to be used in a potential hazardous work environment, may comprise monitoring, by the mobile device, for a gas detector within a first communication range; detecting, by the mobile device, a gas detector within the first communication range; establishing a near field communication connection between the mobile device and the gas detector; sending, by the gas detector to the mobile device, connection data for a Bluetooth connection, wherein the connection data comprises an identifier and a secure PIN; receiving, by the mobile device, the connection data; selecting, by the mobile device, the gas detector using the identifier; and establishing the Bluetooth connection with the gas detector using the secure PIN.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a communication system according to an embodiment of the disclosure.

FIGS. 2A-2B illustrate communication ranges within the communication system shown in FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for establishing a wireless communication link between a mobile device (such as a smart phone and/or tablet), e.g. with a wireless transmitter (e.g. for Bluetooth and/or NFC transmission) and a gas detector. Gas detectors and/or mobile devices may be carried by user while they are working in a potentially hazardous work environment. Current gas detectors may be capable of wirelessly connecting to other devices as well as cloud storage. Typically, to establish a wireless connection between a gas detector and a mobile device, for example using a Bluetooth connection, the mobile device may present a list of the available Bluetooth connections, the user may select the correct gas detector from this list, and then the user may manually input the correct pairing PIN for the correct gas detector. When a user is working in an area with other workers possibly carrying other devices capable of Bluetooth connection, the list of available connections may be long. Additionally, the manual steps of selecting the device/connection and inputting the correct PIN create opportunities for errors, impacting the time and effort required by the user to establish the correct/desired connection.

Embodiments of the disclosure comprise employing a near field communication (NFC) link between the mobile device and the gas detector to establish a Bluetooth connection between the two devices. In other words, NFC between two devices (when they are in close proximity), may act to link the two devices and to automatically activate Bluetooth transmission of gas data from the gas detector to the now linked mobile device. The mobile device may comprise a NFC module and the gas detector may also comprise a NFC module. When the mobile device is placed in proximity (e.g. within NFC range, such as within 10 cm or within 3 cm) to the gas detector, a NFC peer-to-peer (P2P) data exchange may occur between the gas detector and the mobile device, where the data exchange may include identification and connection data associated with the gas detector (e.g. transmitted using NFC from the gas detector to the linked mobile device). For example, the data exchange may include an identifier (ID) associated with the gas detector and a PIN code associated with the gas detector. This information may be automatically (e.g. in response to the NFC data exchange) received and accessed by the mobile device, so that the mobile device can then establish a Bluetooth connection with the gas detector. The identifier may indicate the correct gas detector (possibly from a list of devices and/or gas detectors) and the PIN code may be used to establish a secure wireless connection with the correct gas detector (typically automatically).

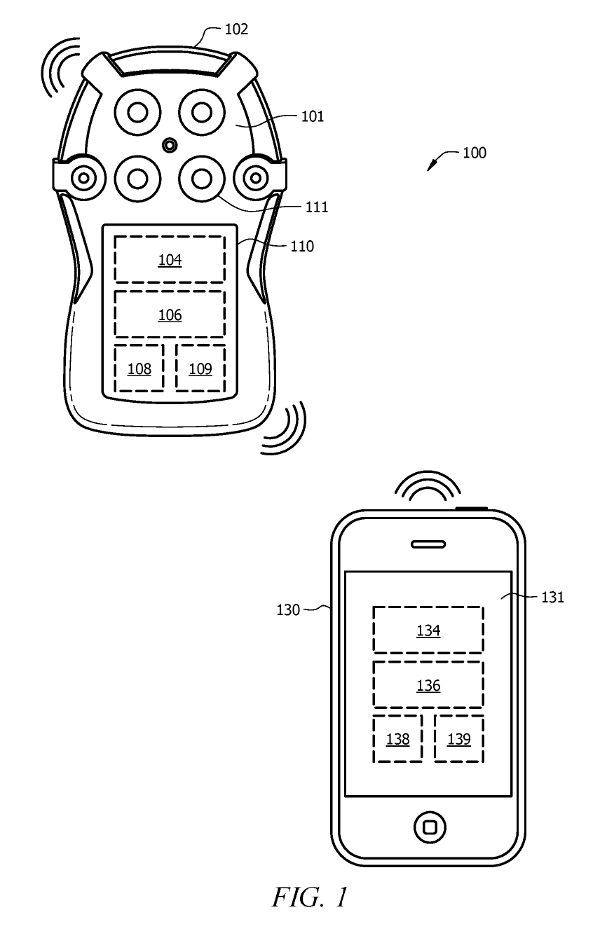

Referring now to FIG. 1, an exemplary communication system 100 is shown. The system 100 may comprise a gas detector 102 configured to detect one or more hazardous and/or harmful gases in the environment and alert a user when such harmful gases are detected. The gas detector 102 may comprise a handheld and/or portable gas detector 102 that may be carried by a user while they are working in a potentially hazardous environment. The gas detector 102 may comprise any type of gas detector configured to detect gas levels in the environment and provide alerts, alarms, and other indications to a user. In some embodiments, the gas detector 102 may comprise a user interface 101. The user interface 101 may be configured to interact with a user, wherein the user interface may comprise a display, one or more lights, one or more beepers, and/or one or more buzzers, as well as possibly other indicators. In the embodiment shown in FIG. 1, the user interface 101 may comprise buttons 111 and/or displays 110.

In some embodiments, the gas detector 102 may comprise a memory 104, a processor 106 configured to access and store to the memory 104, and a wireless communication module (or wireless module) 108. The gas detector 102 may also comprise one or more sensors configured to detect one or more gases and communicate sensed information to the processor 106 and/or memory 104 of the gas detector 102. In some embodiments, the wireless module 108 may be configured to send and/or receive wireless communication with other wireless devices. In some embodiments, the gas detector 102 may comprise a first wireless module 108 and a second wireless module 109 (e.g. the wireless module may comprise two different wireless modules), where the first wireless module 108 may be configured to communicate using a first wireless protocol and where the second wireless module 109 may be configured to communicate using a second wireless protocol. Typically, the two different wireless protocols would have different ranges, for example with the first wireless protocol technology having a shorter range than the second wireless protocol technology. In some embodiments, the first wireless module 108 may comprise a NFC module (e.g. configured to communicate using NFC protocol). In some embodiments, the second wireless module 109 may comprise a Bluetooth (or BLE) module (e.g. configured to communicate using Bluetooth protocol). The one or more wireless modules 108 and 109 may each comprise a transmitter, receiver, and/or transceiver.

The system 100 may also comprise a mobile device 130 configured to provide communication capabilities to the user. The mobile device 130 may comprise a handheld and/or portable mobile device, such as a smart phone and/or tablet, which may be carried by a user while they are working. The mobile device 130 may also comprise a user interface 131 (e.g. a display, button(s), microphone, speaker(s), etc.)

In some embodiments, the mobile device 130 may comprise a memory 134, a processor 136 configured to access and store to the memory 134, and a wireless communication module (or wireless module) 138. In some embodiments, the wireless module 138 may be configured to send and/or receive wireless communication with other wireless devices (e.g. using the same wireless protocol as the gas detector 102 of the system 100). In some embodiments, the mobile device 130 may comprise a first wireless module 138 and a second wireless module 139 (e.g. the wireless module may comprise two different wireless modules), where the first wireless module 138 may be configured to communicate using a first wireless protocol and where the second wireless module 139 may be configured to communicate using a second wireless protocol (generally the same wireless protocols as for the gas detector, as described above). Typically, the two different wireless protocols would have different ranges, for example with the first wireless protocol technology having a shorter range than the second wireless protocol technology. In some embodiments, the first wireless module 138 may comprise a NFC module (e.g. configured to communicate using NFC protocol). In some embodiments, the second wireless module 139 may comprise a Bluetooth (or BLE) module (e.g. configured to communicate using Bluetooth protocol). The one or more wireless modules 138 and 139 may each comprise a transmitter, receiver, and/or transceiver.

In some embodiments, the one or more wireless modules 108 and 109 of the gas detector 102 may perform periodic (and/or continuous) monitoring for a peer device. For example, the first wireless module 108 may periodically monitor for NFC peer devices, and when a peer device is detected, the first wireless module 108 may be configured to connect with and/or communicate with the peer device.

In some embodiments, the one or more wireless modules 138 and 139 of the mobile device 130 may perform periodic (and/or continuous) monitoring for a peer device. For example, the first wireless module 138 may periodically monitor for NFC peer devices, and when a peer device is detected, the first wireless module 138 may be configured to connect with and/or communicate with the peer device. In other words, either the gas detector 102 or the mobile device 130 of the system 100 could be configured to monitor for a peer device (e.g. the other type of device of the system 100)

As an example, the first wireless module 108 of the gas detector 102 may connect with the first wireless module 138 of the mobile device 130 via NFC when the gas detector 102 is placed in proximity to the mobile device 130 (e.g. within NFC protocol range). In some embodiments, the gas detector 102 may be placed within 20 centimeters of the mobile device 130. In some embodiments, the gas detector 102 may be placed within 10 centimeters of the mobile device 130. In some embodiments, the gas detector 102 may be placed within 5 centimeters of the mobile device 130. In some embodiments, the gas detector 102 may be placed within 3 centimeters of the mobile device 130. In some embodiments, the gas detector 102 may be “tapped” with the mobile device 130, i.e. may contact the mobile device 130. Upon detecting a peer device (e.g. within NFC protocol range), near field communication may be established between the two peer devices (e.g. the mobile device 130 and the gas detector 102 of the now formed system 100).

Once the NFC connection is established between the gas detector 102 and the mobile device 130, the gas detector 102 may transmit Bluetooth connection data to the mobile device 130. The Bluetooth connection data may include an identifier for the gas detector 102 and a secure pairing PIN for the gas detector 102. The Bluetooth connection data may enable the mobile device 130 to establish a Bluetooth connection with the gas detector 102 without manual input from the user. In some embodiments, the Bluetooth connection data may be communicated in a NFC data exchange. In some embodiments, the Bluetooth connection data may be communicated using Simple NDEF Exchange Protocol (SNEP) (where NDEF stands for NFC Data Exchange Format).

Once the mobile device 130 receives the Bluetooth connection data, the mobile device 130 (via the processor 136 and/or memory 134) may use the identifier to select the correct gas detector 102 (possibly from a list of available devices, e.g. devices within Bluetooth range of the mobile device 102), and the mobile device 130 may use the secure PIN to establish the Bluetooth connection with the gas detector 102. The Bluetooth connection between the gas detector 102 and the mobile device 130 may allow data to be communicated between the two devices, possibly during the entire work shift for the user. This data may comprise gas detection data, settings information, configuration information, and test and calibration data, among other things. Additionally, the mobile device 130 may be configured to forward data received from the gas detector 102 to other devices, such as a central monitoring station, database, and/or cloud storage (e.g. using Bluetooth or perhaps using a third wireless protocol with a range greater than Bluetooth range, for example cellular and/or radio (in which case the mobile device may further comprise a third wireless module)).

In some embodiments, selecting the gas detector 102 and establishing the Bluetooth connection may occur automatically without input from the user (e.g. the processor 136 of the mobile device 130 may be configured to automatically establish Bluetooth connection using the Bluetooth connection data provided over NFC (e.g. via auto-population)). In some embodiments, the mobile device 130 may be configured to present a confirmation message (or another similar message) to the user during the process of establishing the Bluetooth connection (e.g. so that while the processor auto-populates the connection information, it still gives the user a choice to finalize/confirm the proper connection). In some embodiments, the mobile device 130 may be configured to receive a confirmation input from the user during the process of establishing the Bluetooth connection.

The process of establishing the Bluetooth connection may proceed with minimal input from the user. This may eliminate the opportunity for mistakes by the user, such as selecting the wrong gas detector (which may happen if there are a large number of available gas detectors nearby) as well as incorrect input of the secure PIN (speeding and simplifying the connection process, for example). Additionally, the Bluetooth connection process may occur more quickly than if a user manually connected the devices, allowing for a reduction in preparation time before the user can start working.

The use of NFC to communicate the Bluetooth connection data may provide enhanced security (as well as fine control of the data communication) due to the required physical proximity of the gas detector 102 and mobile device 130.

The use of Bluetooth communication between the gas detector 102 and mobile device 130 may allow for continuous (uninterrupted) communication between the two devices (e.g. during use in the field during a work shift). Additionally, after the initial set-up, the devices may not be required to be in close proximity to one another (e.g. the Bluetooth range may be much larger than the NFC range).

In some embodiments, the gas detector 102 may comprise a stationary gas detector located in a specific work area where the user is working. In this example, the user may establish the Bluetooth connection between the mobile device 130 and the gas detector 102, and then the user may be able to carry the mobile device 130 with them while they are working.

In an exemplary embodiment, the gas detector 102 may be configured to initiate Bluetooth pairing with the mobile device 130 by way of a gas detector initiated NFC P2P data exchange. For example, the mobile device 130 may detect that its NFC field has been externally activated, and may report this event. The gas detector 102 may initiate the P2P connection, where the mobile device 130 may also report this event. As an example, the mobile device 130 may control link management between the two devices, and the gas detector 102 may send a SNEP message. Upon receipt, this message may be indicated by mobile device (e.g. via a user interface to the user).

Upon receiving the message, the mobile device 130 may parse the SNEP payload to obtain the needed information to execute Bluetooth pairing with the gas detector 102. The SNEP payload may comprise the gas detector name (identifier), the MAC address, and the pairing passkey (or secure PIN), along with other relevant data. Once the Bluetooth pairing is established, data (such as sensed gas data) may be transmitted between the gas detector 102 and mobile device 130.

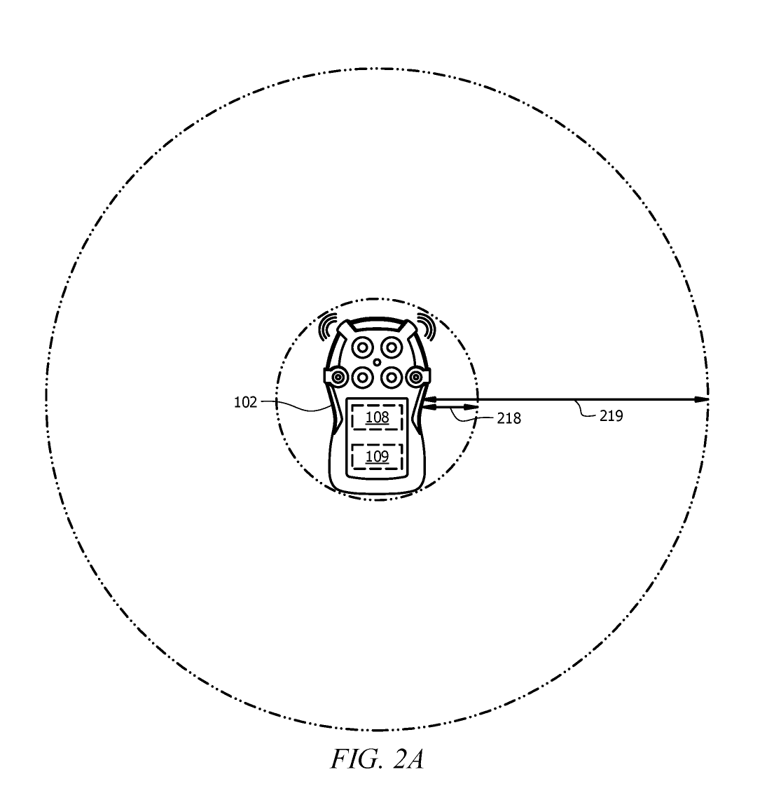

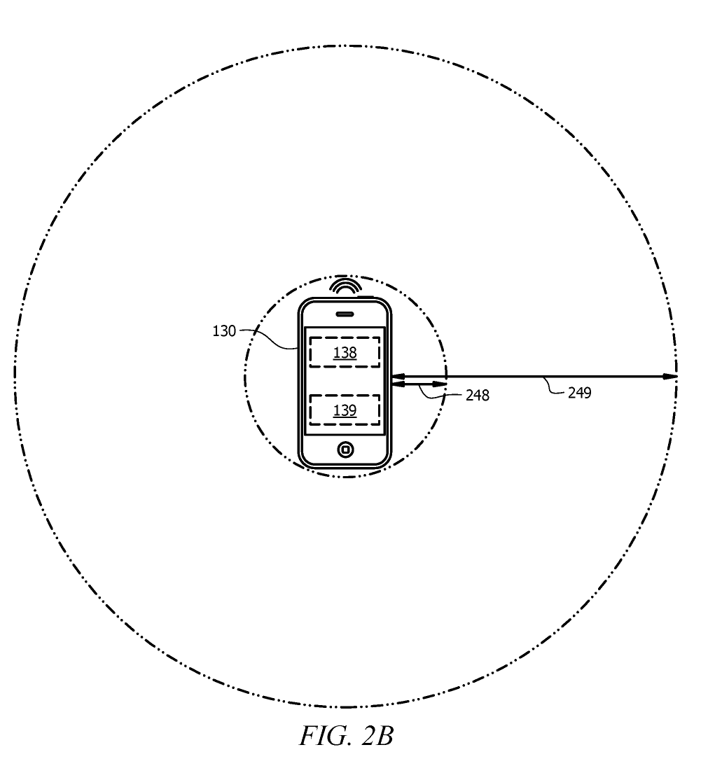

Referring to FIGS. 2A-2B, the communication ranges for the gas detector 102 and the mobile device 130 are shown. These ranges are meant to be illustrative and not exact relative to one another. A first communication range 218 associated with the first wireless module 108 of the gas detector 102 may be significantly smaller than a second communication range 219 associated with the second wireless module 109 of the gas detector 102. As an example, the first communication range 218 for the NFC wireless module 108 may be significantly smaller than the communication range 219 for the Bluetooth wireless module 109. In some embodiments, the ratio of the first communication range 218 to the second communication range 219 may be approximately 1:1000. In some embodiments, the ratio of the first communication range 218 to the second communication range 219 may be between approximately 1:100 and 1:1000. In some embodiments, the ratio of the first communication range 218 to the second communication range 219 may be approximately 1:100. In some embodiments, the ratio of the first communication range 218 to the second communication range 219 may be between approximately 1:50 and 1:1000. In some embodiments, the ratio of the first communication range 218 to the second communication range 219 may be approximately 1:50. For example, the first communication range for NFC might be 20 cm, 10 cm, 5 cm, or 3 cm; while the second communication range for Bluetooth might be 10 m, 20 m, or 100 m.

Similarly, a first communication range 248 associated with the first wireless module 138 of the mobile device 130 may be significantly smaller than a second communication range 249 associated with the second wireless module 139 of the mobile device 130. As an example, the first communication range 248 for the NFC wireless module 138 may be significantly smaller than the second communication range 249 for the Bluetooth wireless module 139. In some embodiments, the ratio of the first communication range 248 to the second communication range 249 may be approximately 1:1000 (or as otherwise described above with respect to the gas detector 102). Since the gas detector 102 and mobile device 130 of the system use the same two wireless protocols, each device should have approximately the same two wireless ranges.

Once the gas detector 102 is within the second communication range 249 of the mobile device 130 (or vice versa), the gas detector 102 may appear as an available Bluetooth device to the mobile device 130. The gas detector 102 may be a fixed, stationary device or the gas detector 102 may be a mobile, handheld device.

Once the gas detector 102 is within the first communication range 248 of the mobile device 130 (or vice versa), the gas detector 102 (and/or mobile device 130) may establish a NFC connection between the device (as described above). Then, once a Bluetooth connection is established between the mobile device 130 and the gas detector 102 (as described above), the gas detector 102 may move out of the first communication range 248 of the mobile device 130 (or vice versa) while remaining with the second communication range 249 (or 219) to maintain Bluetooth communication between the devices (allowing for continued communication between the two linked/parried/peer devices when outside the first communication range but within the second communication range). In some embodiments, once the Bluetooth connection is established between the mobile device 130 and the gas detector 102, the gas detector 102 may move outside of the second communication range 249 of the mobile device 130 (e.g. temporarily losing communication), and then if the gas detector returns to the second communication range 249 of the mobile device 130, the Bluetooth connection may automatically be reestablished (optionally without requiring input from the user and/or NFC connection).

Some embodiments of the disclosure may comprise a method for establishing a Bluetooth connection between a gas detector and a mobile device using NFC (e.g. for a system as described above). A method may comprise monitoring, by one of the gas detector and/or mobile device, for a nearby NFC peer device (where the NFC peer device may comprise the second of the gas detector and/or mobile device). The method may comprise detecting, by one of the gas detector and/or mobile device, a NFC peer device and establishing a NFC connection with the detected NFC peer device (where the NFC peer device may comprise the second of the gas detector and/or mobile device).

The method may comprise sending, by the gas detector to the mobile device, Bluetooth connection data (where the Bluetooth connection data may comprise an identifier and/or secure PIN). The method may comprise receiving, by the mobile device, the Bluetooth connection data, selecting the correct gas detector (possibly from a list of devices) using the identifier, and establishing a Bluetooth connection with the correct gas detector using the secure PIN. In some embodiments, selecting the correct gas detector and establishing the Bluetooth connection may occur automatically once the Bluetooth connection data is received by the mobile device. In some embodiments, selecting the correct gas detector and establishing the Bluetooth connection may occur without input from a user. In some embodiments, the method may comprise receiving a confirmation input from the user before establishing the Bluetooth connection. In some embodiments, the method may comprise sensing one or more gases, by the gas detector, and communicating sensed data from the gas detector to the mobile device. In some embodiments, sensing one or more gases may be completed by one or more sensors within the gas detection, and communication of the sensed data may be completed over the Bluetooth connection between the gas detector and the mobile device.

Having described various devices and methods herein, exemplary embodiments or aspects can include, but are not limited to:

In a first embodiment, a method for establishing a wireless connection between a gas detector and a mobile device may comprise monitoring, by one of the gas detector and/or mobile device, for a peer device within a first communication range, wherein the peer device comprises the second of the gas detector and/or mobile device; detecting, by one of the gas detector and/or mobile device, a peer device within the first communication range; establishing a first wireless connection with the detected peer device; sending, by the gas detector to the mobile device, connection data for a second wireless connection, wherein the connection data comprises an identifier and a secure PIN; receiving, by the mobile device, the connection data; selecting, by the mobile device, the gas detector using the identifier; and establishing the second wireless connection with the gas detector using the secure PIN.

A second embodiment can include the method of the first embodiment, further comprising communicating gas detection data via the second wireless connection while the gas detector is within a second communication range of the mobile device.

A third embodiment can include the method of the first or second embodiments, wherein the first wireless connection comprises a near-field communication (NFC) connection.

A fourth embodiment can include the method of any of the first to third embodiments, wherein the second wireless connection comprises a Bluetooth connection.

A fifth embodiment can include the method of any of the first to fourth embodiments, wherein the gas detector is selected using the identifier from a list of available devices.

A sixth embodiment can include the method of any of the first to fifth embodiments, wherein selecting the gas detector and establishing the second wireless connection occurs automatically once the connection data is received by the mobile device.

A seventh embodiment can include the method of any of the first to sixth embodiments, selecting the gas detector and establishing the second wireless connection occurs without input from a user.

An eighth embodiment can include the method of any of the first to seventh embodiments, further comprising receiving a confirmation input from the user before establishing the second wireless connection.

A ninth embodiment can include the method of any of the first to eighth embodiments, wherein the gas detector is configured to detect (e.g. does detect) hazardous gases in the environment of the user.

A tenth embodiment can include the method of any of the first to ninth embodiments, wherein the gas detector and mobile device are configured to be employed in a potentially hazardous work environment.

In an eleventh embodiment, a communication system may comprise a gas detector configured to detect one or more hazardous gasses, comprising a memory, a processor, a first communication module, and a second communication module; and a mobile device comprising a memory, a processor, a first communication module, and a second communication module, and configured to detect that the gas detector is within a first communication range of the first communication module of the mobile device; establish a first wireless connection, via the first communication module, with the detected gas detector; receive connection data for a second wireless connection, wherein the connection data comprises an identifier and a secure PIN; select the gas detector using the identifier; and establish the second wireless connection with the gas detector using the secure PIN.

A twelfth embodiment can include the communication system of the eleventh embodiment, wherein the first wireless connection is established between the first communication module of the gas detector and the first communication module of the mobile device.

A thirteenth embodiment can include the communication system of the eleventh or twelfth embodiments, wherein the second wireless connection is established between the second communication module of the gas detector and the second communication module of the mobile device.

A fourteenth embodiment can include the communication system of any of the eleventh to thirteenth embodiments, wherein the first wireless connection comprises a near-field communication (NFC) connection, and wherein the second wireless connection comprises a Bluetooth connection.

A fifteenth embodiment can include the communication system of any of the eleventh to fourteenth embodiments, wherein the first communication module of the gas detector and the first communication module of the mobile device communicate within the first communication range, and wherein the second communication module of the gas detector and the second communication module of the mobile device communicate within a second communication range.

In a sixteenth embodiment, a method for establishing a Bluetooth connection between a gas detector and a mobile device, wherein the gas detector is configured to be used in a potential hazardous work environment, may comprise monitoring, by the mobile device, for a gas detector within a first communication range; detecting, by the mobile device, a gas detector within the first communication range; establishing a near field communication connection between the mobile device and the gas detector; sending, by the gas detector to the mobile device, connection data for a Bluetooth connection, wherein the connection data comprises an identifier and a secure PIN; receiving, by the mobile device, the connection data; selecting, by the mobile device, the gas detector using the identifier; and establishing the Bluetooth connection with the gas detector using the secure PIN.

A seventeenth embodiment can include the method of the sixteenth embodiment, further comprising communicating gas detection data via the second wireless connection while the gas detector is within a second communication range of the mobile device.

An eighteenth embodiment can include the method of the sixteenth or seventeenth embodiments, wherein selecting the gas detector and establishing the Bluetooth connection occurs automatically once the connection data is received by the mobile device.

A nineteenth embodiment can include the method of any of the sixteenth to eighteenth embodiments, wherein the gas detector is configured to detect hazardous gases in the environment of the user.

A twentieth embodiment can include the method of any of the sixteenth to nineteenth embodiments, wherein the gas detector and mobile device are configured to be employed in a potentially hazardous work environment.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for establishing a wireless connection between a gas detector and a mobile device, the method comprising:
monitoring, by one of the gas detector and/or mobile device, for a peer device within a first communication range, wherein the peer device comprises the second of the gas detector and/or mobile device;
detecting, by one of the gas detector and/or mobile device, a peer device within the first communication range;
establishing by one of the gas detector and/or mobile device, a first wireless connection within the first communication range with the detected peer device;
sending, by the gas detector to the mobile device via the first wireless connection, connection data for a second wireless connection, wherein the connection data comprises an identifier and a secure PIN;
receiving, by the mobile device, the connection data;
selecting, by the mobile device, the gas detector using the identifier; and
establishing the second wireless connection with the gas detector using the secure PIN, wherein the first communication range is smaller than the second communication range.

2. The method of claim 1, further comprising communicating gas detection data via the second wireless connection while the gas detector is within a second communication range of the mobile device.

3. The method of claim 1, wherein the first wireless connection comprises a near-field communication (NFC) connection.

4. The method of claim 1, wherein the second wireless connection comprises a Bluetooth connection.

5. The method of claim 1, wherein the gas detector is selected using the identifier from a list of available devices.

6. The method of claim 1, wherein selecting the gas detector and establishing the second wireless connection occurs automatically once the connection data is received by the mobile device.

7. The method of claim 1, selecting the gas detector and establishing the second wireless connection occurs without input from a user.

8. The method of claim 1, further comprising receiving a confirmation input from the user before establishing the second wireless connection.

9. The method of claim 1, wherein the gas detector is configured to detect hazardous gases in the environment of the user.

10. The method of claim 1, wherein the gas detector and mobile device are configured to be employed in a potentially hazardous work environment.

11. A communication system comprising:
a gas detector configured to detect one or more hazardous gasses, comprising a memory, a processor, a first communication module, and a second communication module; and
a mobile device comprising a memory, a processor, a first communication module, and a second communication module, and configured to:
detect that the gas detector is within a first communication range of the first communication module of the mobile device;
establish a first wireless connection, via the first communication module, with the detected gas detector;
receive connection data for a second wireless connection, wherein the connection data comprises an identifier and a secure PIN;
select the gas detector using the identifier; and
establish the second wireless connection with the gas detector using the secure PIN.

12. The communication system of claim 11, wherein the first wireless connection is established between the first communication module of the gas detector and the first communication module of the mobile device.

13. The communication system of claim 11, wherein the second wireless connection is established between the second communication module of the gas detector and the second communication module of the mobile device.

14. The communication system of claim 11, wherein the first wireless connection comprises a near-field communication (NFC) connection, and wherein the second wireless connection comprises a Bluetooth connection.

15. The communication system of claim 11, wherein the first communication module of the gas detector and the first communication module of the mobile device communicate within the first communication range, and wherein the second communication module of the gas detector and the second communication module of the mobile device communicate within a second communication range.

16. A method for establishing a Bluetooth connection between a gas detector and a mobile device, wherein the gas detector is configured to be used in a potentially hazardous work environment, the method comprising:
monitoring, by the mobile device, for a gas detector within a first communication range;
detecting, by the mobile device, a gas detector within the first communication range;
establishing a near field communication connection between the mobile device and the gas detector;
sending, by the gas detector to the mobile device, connection data for a Bluetooth connection, wherein the connection data comprises an identifier and a secure PIN;
receiving, by the mobile device, the connection data;
selecting, by the mobile device, the gas detector using the identifier; and
establishing the Bluetooth connection with the gas detector using the secure PIN.

17. The method of claim 16, further comprising communicating gas detection data via the second wireless connection while the gas detector is within a second communication range of the mobile device.

18. The method of claim 16, wherein selecting the gas detector and establishing the Bluetooth connection occurs automatically once the connection data is received by the mobile device.

19. The method of claim 16, wherein the gas detector is configured to detect hazardous gases in the environment of the user.

20. The method of claim 16, wherein the gas detector and mobile device are configured to be employed in a potentially hazardous work environment.
